(19) United States
(12) Patent Application Publication
(10) Pub. No.: US 2024/0404617 A1
(43) Pub. Date: Dec. 5, 2024

(54) RUNTIME ALERT SIGNAL ACTIVATION TEST MODE

(71) Applicant: Intel Corporation, Santa Clara, CA (US)

(72) Inventors: Kuljit S. BAINS, Olympia, WA (US); Shigeki TOMISHIMA, Portland, OR (US)

(21) Appl. No.: 18/805,118

(22) Filed: Aug. 14, 2024

Related U.S. Application Data
(60) Provisional application No. 63/541,728, filed on Sep. 29, 2023.

(51) Int. Cl. G11C 29/46; G11C 29/10; G11C 29/12

(52) U.S. Cl. CPC G11C 29/46; G11C 29/10; G11C 29/1201

(57) ABSTRACT

A system enables an alert signal test mode. The system has an alert signal line between the memory device and the memory controller. The memory device has a register that controls entry into the alert signal test mode. The memory controller sends a command to trigger the memory device to enter the alert signal test mode. In response to the commands, the memory device asserts the alert signal line with an alert signal in response to entry into the alert signal test mode.

### PRIORITY

This application is a nonprovisional application that is based on, and claims the benefit of priority of, U.S. Provisional Application No. 63/541,728.

### TECHNICAL FIELD

Descriptions are generally related to memory systems, and more particular descriptions are related to subsystem signaling.

### BACKGROUND OF THE INVENTION

The interface between a memory device, such as a DRAM (dynamic random access memory) device and a host includes multiple signal lines interconnecting the devices. The interface includes a CA (command/address) bus, a data bus, and one or more additional signal lines. One common signal line is an alert signal line, which the DRAM device can assert to signal an alert condition. The memory controller does not typically know the timing associated with the alert signaling from the memory device.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1 is a block diagram of an example of a system with memory that can perform an alert signal test.

FIG. 2 is a block diagram of an example of a register for triggering an alert test mode.

FIG. 3 is a timing diagram of an example of an alert signal test.

FIG. 4 is a block diagram of an example of a memory device that performs a per row activate count.

FIG. 5 is a block diagram of an example of a system that tracks activates at the memory device.

FIG. 6 is a flow diagram of an example of a process for alert signal testing.

FIG. 7 is a block diagram of an example of a memory subsystem in which alert signal testing can be implemented.

FIGS. 8A-8B are block diagrams of an example of a CAMM system in which alert signal testing can be implemented.

FIG. 9 is a block diagram of an example of a computing system in which alert signal testing can be implemented.

FIG. 10 is a block diagram of an example of a multi-node network in which alert signal testing can be implemented.

Descriptions of certain details and implementations follow, including non-limiting descriptions of the figures, which may depict some or all examples, and well as other potential implementations.

### DETAILED DESCRIPTION OF THE INVENTION

Volatile memory devices, such as DRAM (dynamic random access memory) devices, have a known attack vector referred to as row hammer or row disturb. A row hammer condition refers to the flipping of a bit of an adjacent row (the victim row) by repeated access to a target row (aggressor row) within a time period. The repeated access to the target row causes a change in a value of a victim row that is adjacent or proximate to the target/aggressor row. Repeated activation of the target row causes migration of charge across the passgate of the victim row. With repeated manipulation of a target row with a known pattern, an attacker can intentionally flip bits of victim rows.

With PRHT (perfect row hammer tracking), PRAC (per row activation count), or related techniques, the DRAM device can internally track the number of activates for rows. The DRAM can internally increment an internal counter whose bits are stored in the DRAM row. The storing of the internal activate count ensures that the DRAM knows how many times each row has been activated. Thus, the DRAM can internally monitor for a row hammer condition and trigger an alert signal in response to a row reaching a threshold number of activates.

Recent memory device specifications can support refresh mitigation commands, such as RFM (refresh management) command, ARFM (adaptive refresh management) command, and DRFM (directed refresh management) command to mitigate the attacked neighbor WLs (wordlines). Such commands enable the memory controller to send a command to allow the memory device to mitigate row hammer conditions. In response to the activate tracking, the DRAM can assert an alert signal, and the memory controller can send a refresh mitigation command.

As described herein, a system enables an alert signal test mode. The system has an alert signal line between the memory device and the memory controller. The memory device has a register that controls entry into the alert signal test mode. The memory controller sends a command to trigger the memory device to enter the alert signal test mode. In response to the commands, the memory device asserts the alert signal line with an alert signal in response to entry into the alert signal test mode.

The alert signal line testing enables the system to know the timing of the alert signaling, which can improve the system performance when alert signaling is used to trigger a mitigation response. The new row hammer mitigation techniques involve the sending of an ALERT from the DRAM to the memory controller (the host) by setting the alert signal line. Refresh management (RFM) is a command from the host that allows the DRAM to internally perform refresh. The host sends the RFM command in response to an ALERT.

The alert signal testing can provide an alert signal activation operation for the system to detect and check the mitigation operation during system operation. Thus, alert signal testing can be a runtime operation. For systems, the alert signal test mode makes an easy alert signal activation for the system to check the mitigation function at the system side during system operation.

In one example, the alert signal test mode is an optional test mode for a DRAM device, which can be included to check the ability for the host to handle ALERT_n signal and validate the system mitigation flow. In one example, test mode support is indicated by MR71:OP[6]=1. In one example, the test mode is enabled by setting MR71:OP[7]=1. In one example, the DRAM asserts ALERT_n after a max delay of tMR_ALERT. In one example, the DRAM can set an ABO (alert backoff) flag at MR70: OP[5] indicating that ALERT_n was asserted due to an additional RFM being required. In one example, the test mode field (e.g., MR71 OP[7]) is defined as a write only bit and is self-clearing.

To ensure that the DRAM can refresh the row that triggered a row hammer condition, the host must send an RFM command soon after the row hammer condition occurs. Thus, the system benefits from the ALERT signal having deterministic timing. To determine the timing for the ALERT signal, the memory subsystem can trigger an alert signal test mode.

With the alert signal test mode, the host sets a register bit/field (e.g., an MRW command to set an alert signal test mode bit/field) to trigger the DRAM to enter the alert signal test mode. As soon as the register bit is set, the DRAM will drive the ALERT signal to the host. The host knows when it sets the alert signal test mode, and knows the delay (tMR_ALERT) that the DRAM will take to set the ALERT signal. Thus, based on the test mode, the memory controller knows how long it takes the DRAM to set an ALERT signal.

The response time from MR Write to “ALERT_n” assertion is fairly quick compared to the regular procedure to count ACT issue and detect reaching to the count threshold value. After then, the memory controller can start the row hammer mitigation protocol process, including the hardware and software logical operation at the memory controller side.

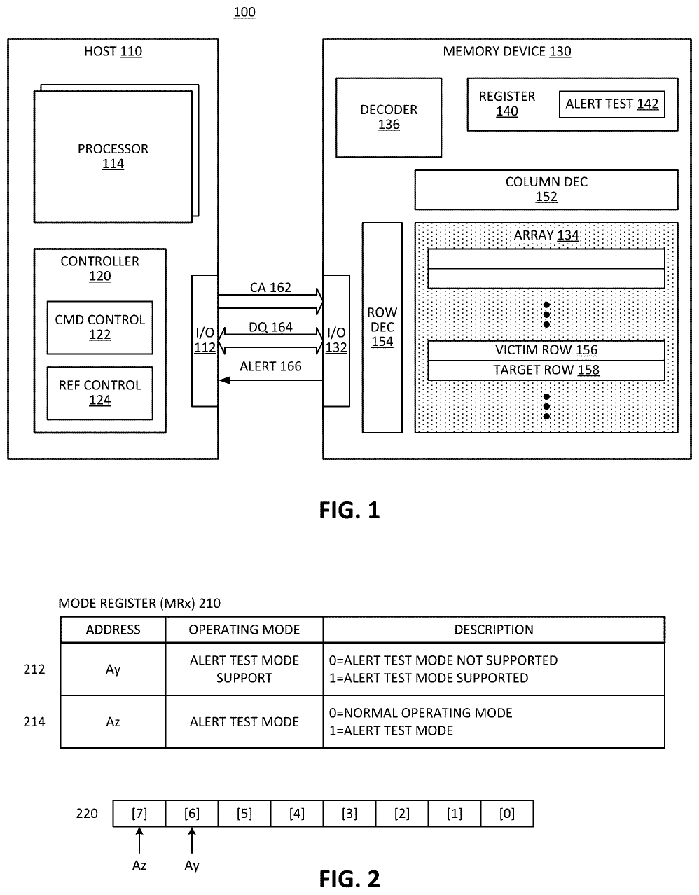

FIG. 1 is a block diagram of an example of a system with memory that can perform an alert signal test. System 100 includes host 110 with processor 114 and controller 120. Controller 120 can be a memory controller. In one example, controller 120 is an integrated memory controller (IMC).

System 100 includes memory device 130 with array 134, which represents the memory array. Memory device 130 includes decoder 136 to decode commands and register 140 to store configuration information. In one example, register 140 is a mode register. Register 140 includes a field or a bit to control an alert test mode. Alert test 142 represents the alert test mode control.

Memory device 130 includes column DEC (decoder) 152 to manage access to specific columns and bits of memory. Memory device 130 includes row DEC (decoder) 154 to manage access to selected rows of memory.

I/O (input/output) 112 represents a hardware interface of host 110 to couple to I/O (input/output) 132 of memory device 130. The interface includes CA (command/address) 162, which represents signal lines for a command and address bus. The CA bus is a unidirectional bus from controller 120 to memory device 130.

The interface includes DQ (data) 164, which represents signal lines for a data bus. The DQ bus is a bidirectional bus allowing host 110 and memory device 130 to exchange data with each other. The interface includes alert 166, which represents an alert signal line through which memory device 130 can send an alert to host 110.

Array 134 illustrates target row 158, which represents a row that is repeated accessed within a refresh window, which can cause a row hammer condition. Victim row 156 represents a row physically proximate to target row 158, which is written as a result of build up of charge on the channel due to repeated access to target row 158.

In one example, controller 120 includes CMD (command) control 122 and REF (refresh) control 124. Command control 122 represents logic in controller 120 to generate and send commands to memory device 130. Refresh control 124 represents logic in controller 120 to generate and send refresh to memory device 130. In one example, memory device 130 tracks row activates and sends an alert signal on alert 166 to controller 120 when a row reaches a threshold number of activates.

In one example, system 100 enables an alert signal test. Host 110, through controller 120, can set alert test 142 of register 140 to trigger memory device 130 to enter an alert signal test mode. Entry into the alert signal test mode enables the determination of timing of the alert signal. In the alert signal test mode, memory device 130 can assert an alert signal as soon as the host triggers the test mode. Thus, controller 120 can determine the expected timing for memory device 130 to assert the alert signal on alert 166.

FIG. 2 is a block diagram of an example of a register for triggering an alert test mode. Mode register 210 represents mode register MRx, which is a mode register designation within the memory device, such as MR71 for mode register 71. Mode register 210 represents a configuration register. Mode register 210 represents an example of a mode register in a DRAM device that supports an alert signal test mode.

As illustrated, address 214 (Az) represents a bit that triggers alert test mode, which represents an alert signal test mode in accordance with any description herein. Address 212 (Ay) represents a bit that indicates support for an alert test mode. While the descriptions refer to a ‘bit,’ it will be understood that a field can include one or more bits. The address can indicate the address of a field or bit.

In an example where Ay represents a bit, a ‘0’ can indicate that alert test mode is not supported, and a ‘1’ can indicate that alert test mode is supported. In an example where Az represents a bit, a ‘0’ can indicate a normal operating mode, and a ‘1’ can indicate the alert test mode. When the alert test mode is set, the memory device can immediately send an alert signal.

Register 220 represents an example of mode register 210, set out as a bit field. As illustrated, the mode register includes 8 bits, with MR[6] (MRx OP[6]) being the address for Ay and MR[7] (MRx OP[7]) being the address for Az.

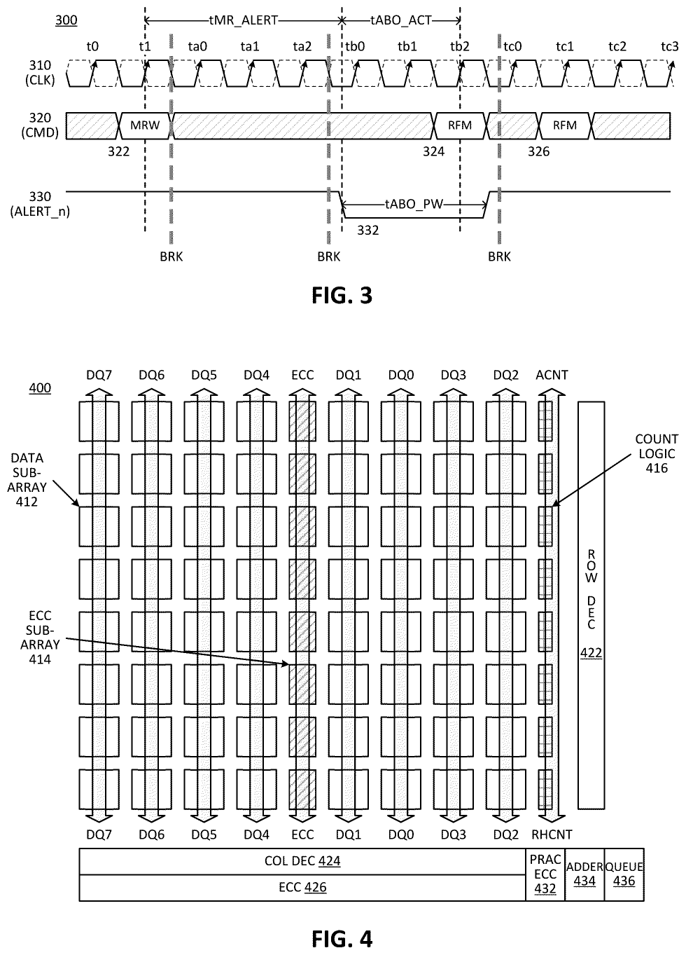

FIG. 3 is a timing diagram of an example of an alert signal test. Diagram 300 represents a timing diagram for a system that implements an alert signal test mode. Signal 310 represents the CLK (clock) signal, with the solid line being the clock signal (CLK_t), and the dashed line being the complement (CLK_c). The times indicate represent examples, where the timing can differ based on how long the breaks/delays are between clock transitions.

Signal 320 represents a CMD (command) signal, indicating a signal provided by the memory controller to the memory device over the CA bus. At 322, the memory controller sends an MRW (mode register write) or other command that triggers the memory device to enter the alert signal test mode. Setting the mode register with an MRW can have a timing in the range of approximately 14 nanoseconds.

Signal 330 represents an Alert_n signal, which indicates that there is a separate alert signal line for each individual memory device to the memory controller. In one example, the memory device immediately asserts the alert signal in response to the MRW command. The time it takes the memory device to assert the alert signal from when the MRW command is issued represents tMR_ALERT, or the delay from the mode register command to the alert signal line transition. In one example, the memory controller sets tMR_ALERT as the maximum time for alert assertion, making the signal determinate, as the memory controller then knows the time delay. The tMR_ALERT can represent a maximum delay from receipt of the mode register command to the time of assertion of the alert signal.

At 332, the memory device drives signal 330. As illustrated, assertion of the alert signal line occurs with a logic low, when ALERT_n is a barred signal (e.g., a zero is an assertion and a one is a deassertion). The memory device interface hardware can pull the alert signal line to a logic low. In one example, the memory device asserts signal 330 for a period of tABO_PW, which is an (ABO) alert back off time. The time tABO_ACT is the minimum time to delay from the alert signal to a subsequent ACT (activate) command.

After tABO_ACT, at 324, the memory controller can send RFM or other command to manage refresh at the memory device. The command at 326 illustrates an RFM command that is sent by the memory controller without being triggered by the alert from the memory device. Thus, the memory controller can send an RFM command in response to a trigger by the memory device, and the memory controller can also schedule an RFM command.

FIG. 4 is a block diagram of an example of a memory device that performs a per row activate count. System 400 represents a memory device that performs activation tracking or PRHT (perfect row hammer tracking). The activation tracking can be referred to as PRAC (per row activation count).

System 400 illustrates a configuration with eight data signal line interfaces (DQs), indicated as DQ7:DQ0. It will be understood that the configuration of the subarrays that provide the bits to the different DQs can be the same as illustrated in system 400, or can be in a different configuration. Additionally, the ECC (error checking and correction) subarrays can be located in a different location.

Data subarray 412 illustrates a subarray for the data DQs. ECC subarray 414 represents a subarray for the ECC bits. Row DEC (decoder) 422 represents row decoding hardware for system 400. COL (column) DEC (decoder) 424 represents column decoding hardware for system 400. ECC 426 represents ECC hardware for internal ECC for system 400. Internal ECC represents ECC hardware at the memory device, for bits stored in the ECC subarrays.

ACNT (activate count) represents the subarray for the activate count (count subarray 416). ACNT represents subarrays to keep counts per row to track activates for a row hammer threshold. The row hammer threshold is the number of activates set/configured for a device to perform refresh to avoid the risk of triggering a row hammer condition. Adder 434 and queue 436 represent logic for system 400 to count and track activates per row. PRAC ECC 432 represents ECC hardware for the count subarrays.

In one example, in response to an activate count reaching a threshold count, the memory device can send an alert signal to the host. The host and the memory device can test the alert signal in accordance with any description herein, to ensure that the memory controller knows the timing for the alert, to schedule a refresh mitigation for the memory device.

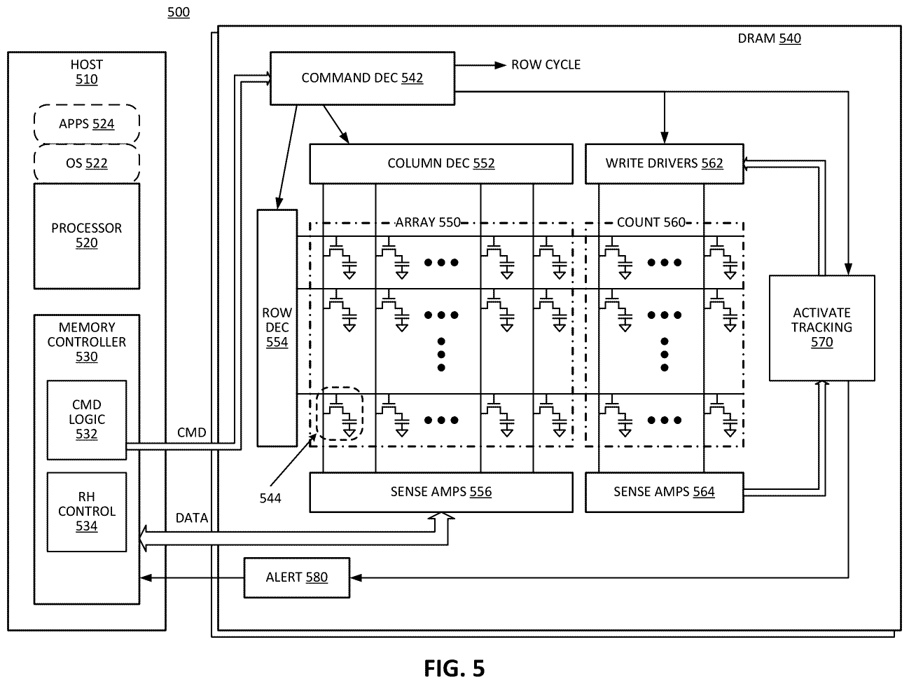

FIG. 5 is a block diagram of an example of a system that tracks activates at the memory device. System 500 provides an example of a system in accordance with an example of system 100 or an example of system 400, where details of the DRAM are illustrated. In system 500, the memory is specifically illustrated as a DRAM (dynamic random access memory) device. DRAM 540 represents one of multiple DRAM devices that can be coupled to host 510.

Host 510 represents a hardware platform for system 500, with processor 520 and memory controller 530. Processor 520 can be referred to as a host processor. Processor 520 executes OS (operating system) 522, and OS 522 provides a software platform for system 500, on which other applications and processes will execute on the hardware platform of host 510. Applications (APPS) 524 represent other applications or services in system 500. The execution of OS 522 and applications 524 generate access requests for DRAM 540.

Memory controller 530 manages access to DRAM 540. In one example, memory controller 530 includes command (CMD) logic 532 to generate access commands to send to DRAM 540. The command is represented as CMD over a command bus to DRAM 540. The command can be any type of command that generates or is accompanied by an activate command. In one example, command logic 532 generates a command to indicate the count DRAM 540 should use to increment its internal activate count. The command can be an activate command, a precharge command, or another command with a field to indicate incrementing the memory-side activate count.

In one example, memory controller 530 includes row hammer (RH) control 534, which represents circuitry or logic at memory controller 530 to determine when to send a command to allow DRAM 540 to mitigate a row hammer condition.

System 500 also illustrates a data bus, represented as DATA, coupling memory controller 530 to DRAM 540 to exchange data. The command bus is a unilateral bus and the data bus is a bidirectional bus.

DRAM 540 includes a memory array with multiple bitcells 544, which represents a memory cell or a storage location of the memory array. Bitcell 544 connects to a wordline (WL) and a bitline (BL), with the specific WL/BL location representing an address identifiable by a combination of row (WL) and column (BL) address, which may also require a bank and bank group address to specify a portion of the array to access.

Row decoder (DEC) 554 represents decoding hardware to select rows or wordlines for read, write, or other access. Column decoder (DEC) 552 represents decoding hardware to select columns or bitlines. Typically, selection includes charging a row and columns to access a group of bitcells. DRAM 540 does not specifically illustrate the banks, but it will be understood that the bitcell array can be organized as banks and bank groups. Sense amps (amplifiers) 556 represent sense amplifiers to stage data for access to array 550. For a write, write data is written into sense amps 556 and then into array 550. For a read, data is read from array 550 into sense amps 556, to return to memory controller 530 over the data bus.

DRAM 540 includes array 550, which represents a core memory cell array to store data. Count 560 represents memory cells to store an activation count or activate count for each row. In one example, count 560 represents bits at the end of each row of array 550 to provide storage for the count. Count 560 holds a value to indicate a number of activates since a last refresh of the row, and can be reset on refresh.

When memory controller 530 sends a memory access command to DRAM 540, command decoder (DEC) 542 identifies the command and controls appropriate column decoder circuitry and row decoder circuitry to select the specified address. In one example, each command that triggers an activation of a row of array 550 causes activate tracking 570 to increment count 560.

Each time a command from memory controller 530 triggers a row activation, circuitry in DRAM 540, represented by activate tracking 570, can read count 560 for the selected row into sense amps 564. The value is the count value, which can be compared with a comparator to a threshold value. If the row activation count for any particular row reaches the threshold, the memory chip recognizes the existence of a row hammer condition for the particular row. Activate tracking 570 can write the count back to count 560 through write devices 562.

In one example, when activate tracking 570 identifies a row hammer condition, it can trigger DRAM 540 to assert the alert signal. Alert 580 represents the hardware interface to drive the alert signal line to host 510.

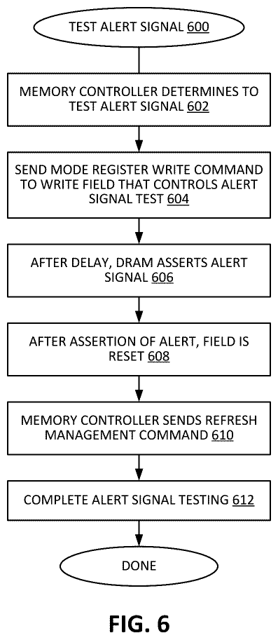

FIG. 6 is a flow diagram of an example of a process for alert signal testing. Process 600 illustrates an example of testing an alert signal in accordance with any example system herein. In one example, the memory controller determines to test an alert signal, at 602. The testing can be part of an initialization routine. In one example, the memory controller sends a mode register write command to write a field that controls an alert signal test, at 604.

After an alert test delay (e.g., tMR_alert), the DRAM device drives the alert signal line to assert the alert signal, at 606. In one example, after assertion of the alert, the field controlling alert signal testing can be reset, at 608. In one example, the memory controller can write to the field to reset it, at 610. In one example, the field automatically resets after assertion of the alert signal. In one example, the field automatically resets after a delay period after the field is set.

In one example, the memory controller sends a command to allow the DRAM device to perform refresh internally. For example, the memory controller can send a DRFM, an RFM, or an ARFM command. In one example, the system can perform other operations to complete the alert signal testing, at 612.

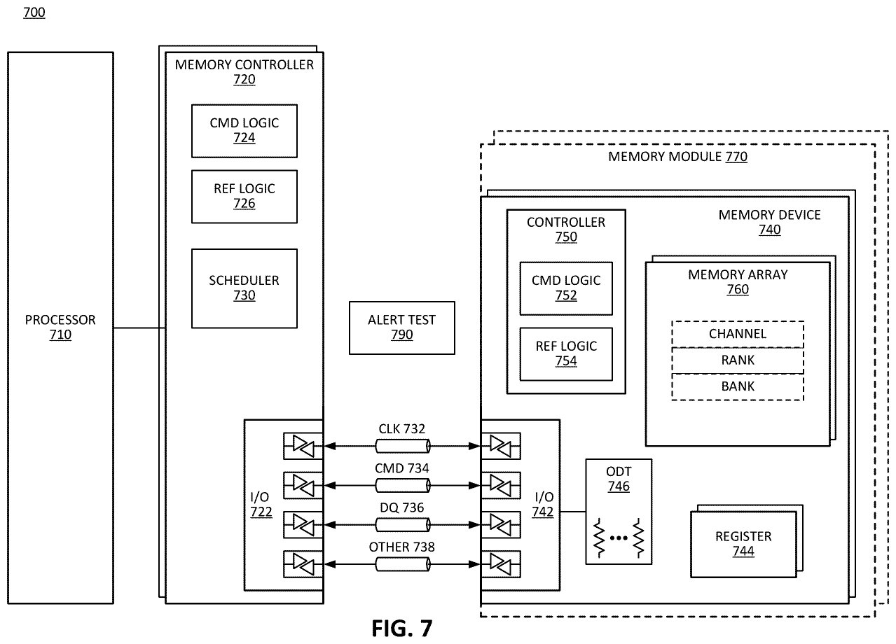

FIG. 7 is a block diagram of an example of a memory subsystem in which alert signal testing can be implemented. System 700 includes a processor and elements of a memory subsystem in a computing device. System 700 is an example of a system in accordance with an example of system 100, system 400, or system 500.

In one example, system 700 includes alert test 790, which represents logic in memory controller 720, logic in memory device 740, or a combination of logic in memory controller 720 and in memory device 740, to implement an alert signal test mode in accordance with any example herein.

Processor 710 represents a processing unit of a computing platform that may execute an operating system (OS) and applications, which can collectively be referred to as the host or the user of the memory. The OS and applications execute operations that result in memory accesses. Processor 710 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory accesses may also be initiated by devices such as a network controller or hard disk controller. Such devices can be integrated with the processor in some systems or attached to the processer via a bus (e.g., PCI express), or a combination. System 700 can be implemented as an SOC (system on a chip), or be implemented with standalone components.

Reference to memory devices can apply to different memory types. Memory devices often refers to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random-access memory), or some variant such as synchronous DRAM (SDRAM). A memory subsystem as described herein may be compatible with a number of memory technologies, such as DDR4 (double data rate version 4, JESD79-4, originally published in September 2012 by JEDEC (Joint Electron Device Engineering Council, now the JEDEC Solid State Technology Association), LPDDR4 (low power DDR version 4, JESD209-4, originally published by JEDEC in August 2014), WIO2 (Wide I/O 2 (WideIO2), JESD229-2, originally published by JEDEC in August 2014), HBM (high bandwidth memory DRAM, JESD235A, originally published by JEDEC in November 2015), DDR5 (DDR version 5, originally published by JEDEC in July 2020), LPDDR5 (LPDDR version 5, JESD209-5, originally published by JEDEC in February 2019), HBM2 (HBM version 2, JESD235C, originally published by JEDEC in January 2020), HBM3 (HBM version 3, JESD238, originally published by JEDEC in January 2022), or others or combinations of memory technologies, and technologies based on derivatives or extensions of such specifications.

Memory controller 720 represents one or more memory controller circuits or devices for system 700. Memory controller 720 represents control logic that generates memory access commands in response to the execution of operations by processor 710. Memory controller 720 accesses one or more memory devices 740. Memory devices 740 can be DRAM devices in accordance with any referred to above. In one example, memory devices 740 are organized and managed as different channels, where each channel couples to buses and signal lines that couple to multiple memory devices in parallel. Each channel is independently operable. Thus, each channel is independently accessed and controlled, and the timing, data transfer, command and address exchanges, and other operations are separate for each channel. Coupling can refer to an electrical coupling, communicative coupling, physical coupling, or a combination of these. Physical coupling can include direct contact. Electrical coupling includes an interface or interconnection that allows electrical flow between components, or allows signaling between components, or both. Communicative coupling includes connections, including wired or wireless, that enable components to exchange data.

In one example, settings for each channel are controlled by separate mode registers or other register settings. In one example, each memory controller 720 manages a separate memory channel, although system 700 can be configured to have multiple channels managed by a single controller, or to have multiple controllers on a single channel. In one example, memory controller 720 is part of host processor 710, such as logic implemented on the same die or implemented in the same package space as the processor.

Memory controller 720 includes I/O interface logic 722 to couple to a memory bus, such as a memory channel as referred to above. I/O interface logic 722 (as well as I/O interface logic 742 of memory device 740) can include pins, pads, connectors, signal lines, traces, or wires, or other hardware to connect the devices, or a combination of these. I/O interface logic 722 can include a hardware interface. As illustrated, I/O interface logic 722 includes at least drivers/transceivers for signal lines. Commonly, wires within an integrated circuit interface couple with a pad, pin, or connector to interface signal lines or traces or other wires between devices. I/O interface logic 722 can include drivers, receivers, transceivers, or termination, or other circuitry or combinations of circuitry to exchange signals on the signal lines between the devices. The exchange of signals includes at least one of transmit or receive. While shown as coupling I/O 722 from memory controller 720 to I/O 742 of memory device 740, it will be understood that in an implementation of system 700 where groups of memory devices 740 are accessed in parallel, multiple memory devices can include I/O interfaces to the same interface of memory controller 720. In an implementation of system 700 including one or more memory modules 770, I/O 742 can include interface hardware of the memory module in addition to interface hardware on the memory device itself. Other memory controllers 720 will include separate interfaces to other memory devices 740.

The bus between memory controller 720 and memory devices 740 can be implemented as multiple signal lines coupling memory controller 720 to memory devices 740. The bus may typically include at least clock (CLK) 732, command/address (CMD) 734, and write data (DQ) and read data (DQ) 736, and zero or more other signal lines 738. In one example, a bus or connection between memory controller 720 and memory can be referred to as a memory bus. In one example, the memory bus is a multi-drop bus. The signal lines for CMD can be referred to as a “C/A bus” (or ADD/CMD bus, or some other designation indicating the transfer of commands (C or CMD) and address (A or ADD) information) and the signal lines for write and read DQ can be referred to as a “data bus.” In one example, independent channels have different clock signals, C/A buses, data buses, and other signal lines. Thus, system 700 can be considered to have multiple “buses,” in the sense that an independent interface path can be considered a separate bus. It will be understood that in addition to the lines explicitly shown, a bus can include at least one of strobe signaling lines, alert lines, auxiliary lines, or other signal lines, or a combination. It will also be understood that serial bus technologies can be used for the connection between memory controller 720 and memory devices 740. An example of a serial bus technology is 8B10B encoding and transmission of high-speed data with embedded clock over a single differential pair of signals in each direction. In one example, CMD 734 represents signal lines shared in parallel with multiple memory devices. In one example, multiple memory devices share encoding command signal lines of CMD 734, and each has a separate chip select (CS_n) signal line to select individual memory devices.

It will be understood that in the example of system 700, the bus between memory controller 720 and memory devices 740 includes a subsidiary command bus CMD 734 and a subsidiary bus to carry the write and read data, DQ 736. In one example, the data bus can include bidirectional lines for read data and for write/command data. In another example, the subsidiary bus DQ 736 can include unidirectional write signal lines for write and data from the host to memory, and can include unidirectional lines for read data from the memory to the host. In accordance with the chosen memory technology and system design, other signals 738 may accompany a bus or sub bus, such as strobe lines DQS. Based on design of system 700, or implementation if a design supports multiple implementations, the data bus can have more or less bandwidth per memory device 740. For example, the data bus can support memory devices that have either a x4 interface, a x8 interface, a x16 interface, or other interface. The convention “xW,” where W is an integer that refers to an interface size or width of the interface of memory device 740, which represents a number of signal lines to exchange data with memory controller 720. The interface size of the memory devices is a controlling factor on how many memory devices can be used concurrently per channel in system 700 or coupled in parallel to the same signal lines. In one example, high bandwidth memory devices, wide interface devices, or stacked memory configurations, or combinations, can enable wider interfaces, such as a x128 interface, a x256 interface, a x512 interface, a x1024 interface, or other data bus interface width.

In one example, memory devices 740 and memory controller 720 exchange data over the data bus in a burst, or a sequence of consecutive data transfers. The burst corresponds to a number of transfer cycles, which is related to a bus frequency. In one example, the transfer cycle can be a whole clock cycle for transfers occurring on a same clock or strobe signal edge (e.g., on the rising edge). In one example, every clock cycle, referring to a cycle of the system clock, is separated into multiple unit intervals (UIs), where each UI is a transfer cycle. For example, double data rate transfers trigger on both edges of the clock signal (e.g., rising and falling). A burst can last for a configured number of UIs, which can be a configuration stored in a register, or triggered on the fly. For example, a sequence of eight consecutive transfer periods can be considered a burst length eight (BL8), and each memory device 740 can transfer data on each UI. Thus, a x8 memory device operating on BL8 can transfer 64 bits of data (8 data signal lines times 8 data bits transferred per line over the burst). It will be understood that this simple example is merely an illustration and is not limiting.

Memory devices 740 represent memory resources for system 700. In one example, each memory device 740 is a separate memory die. In one example, each memory device 740 can interface with multiple (e.g., 2) channels per device or die. Each memory device 740 includes I/O interface logic 742, which has a bandwidth determined by the implementation of the device (e.g., x16 or x8 or some other interface bandwidth). I/O interface logic 742 enables the memory devices to interface with memory controller 720. I/O interface logic 742 can include a hardware interface, and can be in accordance with I/O 722 of memory controller, but at the memory device end. In one example, multiple memory devices 740 are connected in parallel to the same command and data buses. In another example, multiple memory devices 740 are connected in parallel to the same command bus, and are connected to different data buses. For example, system 700 can be configured with multiple memory devices 740 coupled in parallel, with each memory device responding to a command, and accessing memory resources 760 internal to each. For a Write operation, an individual memory device 740 can write a portion of the overall data word, and for a Read operation, an individual memory device 740 can fetch a portion of the overall data word. The remaining bits of the word will be provided or received by other memory devices in parallel.

In one example, memory devices 740 are disposed directly on a motherboard or host system platform (e.g., a PCB (printed circuit board) or substrate on which processor 710 is disposed) of a computing device. In one example, memory devices 740 can be organized into memory modules 770. In one example, memory modules 770 represent dual inline memory modules (DIMMs). In one example, memory modules 770 represent other organization of multiple memory devices to share at least a portion of access or control circuitry, which can be a separate circuit, a separate device, or a separate board from the host system platform. Memory modules 770 can include multiple memory devices 740, and the memory modules can include support for multiple separate channels to the included memory devices disposed on them. In another example, memory devices 740 may be incorporated into the same package as memory controller 720, such as by techniques such as multi-chip-module (MCM), package-on-package, through-silicon via (TSV), or other techniques or combinations. Similarly, in one example, multiple memory devices 740 may be incorporated into memory modules 770, which themselves may be incorporated into the same package as memory controller 720. It will be appreciated that for these and other implementations, memory controller 720 may be part of host processor 710.

Memory devices 740 each include one or more memory arrays 760. Memory array 760 represents addressable memory locations or storage locations for data. Typically, memory array 760 is managed as rows of data, accessed via wordline (rows) and bitline (individual bits within a row) control. Memory array 760 can be organized as separate channels, ranks, and banks of memory. Channels may refer to independent control paths to storage locations within memory devices 740. Ranks may refer to common locations across multiple memory devices (e.g., same row addresses within different devices) in parallel. Banks may refer to sub-arrays of memory locations within a memory device 740. In one example, banks of memory are divided into sub-banks with at least a portion of shared circuitry (e.g., drivers, signal lines, control logic) for the sub-banks, allowing separate addressing and access. It will be understood that channels, ranks, banks, sub-banks, bank groups, or other organizations of the memory locations, and combinations of the organizations, can overlap in their application to physical resources. For example, the same physical memory locations can be accessed over a specific channel as a specific bank, which can also belong to a rank. Thus, the organization of memory resources will be understood in an inclusive, rather than exclusive, manner.

In one example, memory devices 740 include one or more registers 744. Register 744 represents one or more storage devices or storage locations that provide configuration or settings for the operation of the memory device. In one example, register 744 can provide a storage location for memory device 740 to store data for access by memory controller 720 as part of a control or management operation. In one example, register 744 includes one or more Mode Registers. In one example, register 744 includes one or more multipurpose registers. The configuration of locations within register 744 can configure memory device 740 to operate in different “modes,” where command information can trigger different operations within memory device 740 based on the mode. Additionally or in the alternative, different modes can also trigger different operation from address information or other signal lines depending on the mode. Settings of register 744 can indicate configuration for I/O settings (e.g., timing, termination or ODT (on-die termination) 746, driver configuration, or other I/O settings).

In one example, memory device 740 includes ODT 746 as part of the interface hardware associated with I/O 742. ODT 746 can be configured as mentioned above, and provide settings for impedance to be applied to the interface to specified signal lines. In one example, ODT 746 is applied to DQ signal lines. In one example, ODT 746 is applied to command signal lines. In one example, ODT 746 is applied to address signal lines. In one example, ODT 746 can be applied to any combination of the preceding. The ODT settings can be changed based on whether a memory device is a selected target of an access operation or a non-target device. ODT 746 settings can affect the timing and reflections of signaling on the terminated lines. Careful control over ODT 746 can enable higher-speed operation with improved matching of applied impedance and loading. ODT 746 can be applied to specific signal lines of I/O interface 742, 722 (for example, ODT for DQ lines or ODT for CA lines), and is not necessarily applied to all signal lines.

Memory device 740 includes controller 750, which represents control logic within the memory device to control internal operations within the memory device. For example, controller 750 decodes commands sent by memory controller 720 and generates internal operations to execute or satisfy the commands. Controller 750 can be referred to as an internal controller, and is separate from memory controller 720 of the host. Controller 750 can determine what mode is selected based on register 744, and configure the internal execution of operations for access to memory resources 760 or other operations based on the selected mode. Controller 750 generates control signals to control the routing of bits within memory device 740 to provide a proper interface for the selected mode and direct a command to the proper memory locations or addresses. Controller 750 includes command logic 752, which can decode command encoding received on command and address signal lines. Thus, command logic 752 can be or include a command decoder. With command logic 752, memory device can identify commands and generate internal operations to execute requested commands.

Referring again to memory controller 720, memory controller 720 includes command (CMD) logic 724, which represents logic or circuitry to generate commands to send to memory devices 740. The generation of the commands can refer to the command prior to scheduling, or the preparation of queued commands ready to be sent. Generally, the signaling in memory subsystems includes address information within or accompanying the command to indicate or select one or more memory locations where the memory devices should execute the command. In response to scheduling of transactions for memory device 740, memory controller 720 can issue commands via I/O 722 to cause memory device 740 to execute the commands. In one example, controller 750 of memory device 740 receives and decodes command and address information received via I/O 742 from memory controller 720. Based on the received command and address information, controller 750 can control the timing of operations of the logic and circuitry within memory device 740 to execute the commands. Controller 750 is responsible for compliance with standards or specifications within memory device 740, such as timing and signaling requirements. Memory controller 720 can implement compliance with standards or specifications by access scheduling and control.

Memory controller 720 includes scheduler 730, which represents logic or circuitry to generate and order transactions to send to memory device 740. From one perspective, the primary function of memory controller 720 could be said to schedule memory access and other transactions to memory device 740. Such scheduling can include generating the transactions themselves to implement the requests for data by processor 710 and to maintain integrity of the data (e.g., such as with commands related to refresh). Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity, or other commands or a combination.

Memory controller 720 typically includes logic such as scheduler 730 to allow selection and ordering of transactions to improve performance of system 700. Thus, memory controller 720 can select which of the outstanding transactions should be sent to memory device 740 in which order, which is typically achieved with logic much more complex that a simple first-in first-out algorithm. Memory controller 720 manages the transmission of the transactions to memory device 740, and manages the timing associated with the transaction. In one example, transactions have deterministic timing, which can be managed by memory controller 720 and used in determining how to schedule the transactions with scheduler 730.

In one example, memory controller 720 includes refresh (REF) logic 726. Refresh logic 726 can be used for memory resources that are volatile and need to be refreshed to retain a deterministic state. In one example, refresh logic 726 indicates a location for refresh, and a type of refresh to perform. Refresh logic 726 can trigger self-refresh within memory device 740, or execute external refreshes which can be referred to as auto refresh commands) by sending refresh commands, or a combination. In one example, controller 750 within memory device 740 includes refresh logic 754 to apply refresh within memory device 740. In one example, refresh logic 754 generates internal operations to perform refresh in accordance with an external refresh received from memory controller 720. Refresh logic 754 can determine if a refresh is directed to memory device 740, and what memory resources 760 to refresh in response to the command.

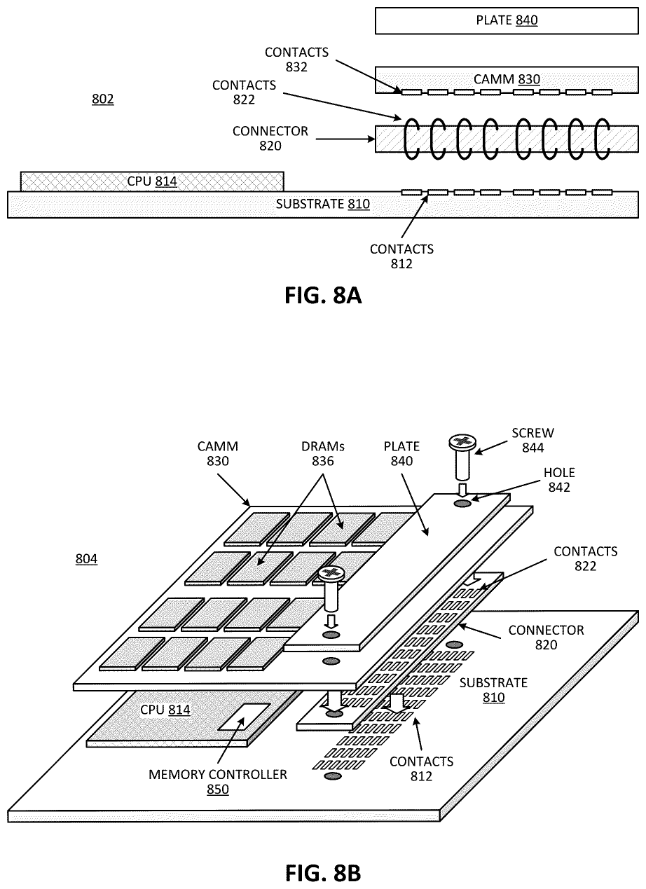

FIGS. 8A-8B are block diagrams of an example of a CAMM system in which alert signal testing can be implemented.

Referring to FIG. 8A, system 802 includes a memory stack architecture monitored by a memory fault tracker that can perform mirroring. System 802 is an example of a system in accordance with an example of system 100, system 400, or system 500.

Substrate 810 illustrates an SOC package substrate or a motherboard or system board. Substrate 810 includes contacts 812, which represent contacts for connecting with memory. CPU 814 represents a processor or central processing unit (CPU) chip or graphics processing unit (GPU) chip to be disposed on substrate 810. CPU 814 performs the computational operations in system 802. In one example, CPU 814 includes multiple cores (not specifically shown), which can generate operations that request data to be read from and written to memory. CPU 814 can include a memory controller to manage access to the memory devices.

Compression-attached memory module (CAMM) 830 represents a module with memory devices, which are not specifically illustrated in system 802. Substrate 810 couples to CAMM 830 and its memory devices through compression mount technology (CMT) connector 820. Connector 820 includes contacts 822, which are compression-based contacts. The compression-based contacts are compressible pins or devices whose shape compresses with the application of pressure on connector 820. In one example, contacts 822 represent C-shaped pins as illustrated. In one example, contacts 822 represent another compressible pin shape, such as a spring-shape, an S-shape, or pins having other shapes that can be compressed.

CAMM 830 includes contacts 832 on a side of the CAMM board that interfaces with connector 820. Contacts 832 connect to memory devices on the CAMM board. Plate 840 represents a plate or housing that provides structure to apply pressure to compress contacts 822 of connector 820.

Referring to FIG. 8B, system 804 is a perspective view of a system in accordance with system 802. System 804 illustrates memory controller 850, which is not specifically illustrated in system 802. Memory controller 850 can provide row hammer mitigation to DRAMs 836. DRAMs 836 can be connected to memory controller 850 with an alert signal line. System 804 enables DRAMs 836 to perform an alert signal test mode with memory controller 850 in accordance with any example herein.

CAMM 830 is illustrated with memory chips or memory dies, identified as DRAMs 836 on one or both faces of the PCB of CAMM 830. DRAMs 836 are coupled with conductive contacts via conductive traces in or on the PCB, which couples with contacts 832, which in turn couple with contacts 822 of connector 820.

System 804 illustrates holes 842 in plate 840 to receive fasteners, represented by screws 844. There are corresponding holes through CAMM 830, connector 820, and in substrate 810. Screws 844 can compressibly attach the CAMM 830 to substrate 810 via connector 820.

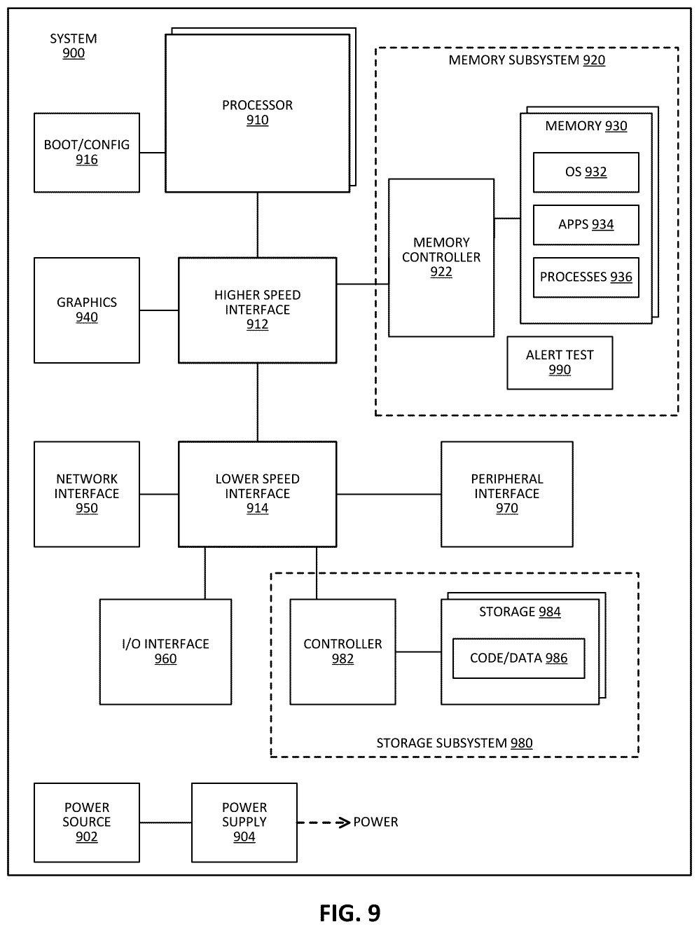

FIG. 9 is a block diagram of an example of a computing system in which alert signal testing can be implemented. System 900 represents a computing device in accordance with any example herein, and can be a laptop computer, a desktop computer, a tablet computer, a server, a gaming or entertainment control system, embedded computing device, or other electronic device.

System 900 is an example of a system in accordance with an example of system 100, system 400, or system 500. In one example, system 900 includes alert test 990, which represents logic in memory controller 922, logic in memory 930, or a combination of logic in memory controller 922 and in memory 930, to implement an alert signal test mode in accordance with any example herein.

System 900 includes processor 910 can include any type of microprocessor, central processing unit (CPU), graphics processing unit (GPU), processing core, or other processing hardware, or a combination, to provide processing or execution of instructions for system 900. Processor 910 can be a host processor device. Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or a combination of such devices.

System 900 includes boot/config 916, which represents storage to store boot code (e.g., basic input/output system (BIOS)), configuration settings, security hardware (e.g., trusted platform module (TPM)), or other system level hardware that operates outside of a host OS. Boot/config 916 can include a nonvolatile storage device, such as read-only memory (ROM), flash memory, or other memory devices.

In one example, system 900 includes interface 912 coupled to processor 910, which can represent a higher speed interface or a high throughput interface for system components that need higher bandwidth connections, such as memory subsystem 920 or graphics interface components 940. Interface 912 represents an interface circuit, which can be a standalone component or integrated onto a processor die. Interface 912 can be integrated as a circuit onto the processor die or integrated as a component on a system on a chip. Where present, graphics interface 940 interfaces to graphics components for providing a visual display to a user of system 900. Graphics interface 940 can be a standalone component or integrated onto the processor die or system on a chip. In one example, graphics interface 940 can drive a high definition (HD) display or ultra high definition (UHD) display that provides an output to a user. In one example, the display can include a touchscreen display. In one example, graphics interface 940 generates a display based on data stored in memory 930 or based on operations executed by processor 910 or both.

Memory subsystem 920 represents the main memory of system 900, and provides storage for code to be executed by processor 910, or data values to be used in executing a routine. Memory subsystem 920 can include one or more varieties of random-access memory (RAM) such as DRAM, 3DXP (three-dimensional crosspoint), or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910, such as integrated onto the processor die or a system on a chip.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or other bus, or a combination.

In one example, system 900 includes interface 914, which can be coupled to interface 912. Interface 914 can be a lower speed interface than interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can exchange data with a remote device, which can include sending data stored in memory or receiving data to be stored in memory.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, NAND, 3DXP, or optical based disks, or a combination. Storage 984 holds code or instructions and data 986 in a persistent state (i.e., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (i.e., the value or state of the data is indeterminate if power is interrupted to system 900). In one example, storage subsystem 980 includes controller 982 to interface with storage 984. In one example controller 982 is a physical part of interface 914 or processor 910, or can include circuits or logic in both processor 910 and interface 914.

Power source 902 provides power to the components of system 900. More specifically, power source 902 typically interfaces to one or multiple power supplies 904 in system 900 to provide power to the components of system 900. In one example, power supply 904 includes an AC to DC (alternating current to direct current) adapter to plug into a wall outlet. Such AC power can be renewable energy (e.g., solar power) power source 902. In one example, power source 902 includes a DC power source, such as an external AC to DC converter. In one example, power source 902 or power supply 904 includes wireless charging hardware to charge via proximity to a charging field. In one example, power source 902 can include an internal battery or fuel cell source.

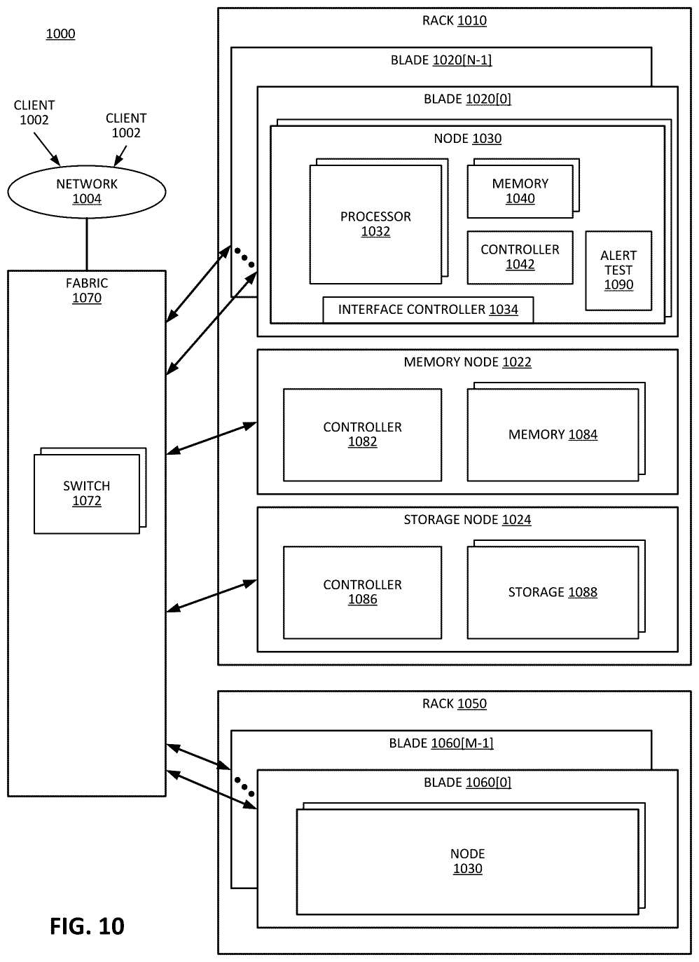

FIG. 10 is a block diagram of an example of a multi-node network in which alert signal testing can be implemented. In one example, system 1000 represents a data center. In one example, system 1000 represents a server farm. In one example, system 1000 represents a data cloud or a processing cloud.

Nodes 1030 of system 1000 represent a system in accordance with an example of system 100, system 400, or system 500. In one example, node 1030 includes alert test 1090, which represents logic in controller 1042, logic in memory 1040, or a combination of logic in controller 1042 and in memory 1040, to implement an alert signal test mode in accordance with any example herein.

One or more clients 1002 make requests over network 1004 to system 1000. Network 1004 represents one or more local networks, or wide area networks, or a combination. Clients 1002 can be human or machine clients, which generate requests for the execution of operations by system 1000. System 1000 executes applications or data computation tasks requested by clients 1002.

In one example, system 1000 includes one or more racks, which represent structural and interconnect resources to house and interconnect multiple computation nodes. In one example, rack 1010 includes multiple nodes 1030. In one example, rack 1010 hosts multiple blade components, blade 1020 [0], . . . , blade 1020 [N−1], collectively blades 1020. Hosting refers to providing power, structural or mechanical support, and interconnection. Blades 1020 can refer to computing resources on printed circuit boards (PCBs), where a PCB houses the hardware components for one or more nodes 1030. In one example, blades 1020 do not include a chassis or housing or other “box” other than that provided by rack 1010. In one example, blades 1020 include housing with exposed connector to connect into rack 1010. In one example, system 1000 does not include rack 1010, and each blade 1020 includes a chassis or housing that can stack or otherwise reside in close proximity to other blades and allow interconnection of nodes 1030.

System 1000 includes fabric 1070, which represents one or more interconnectors for nodes 1030. In one example, fabric 1070 includes multiple switches 1072 or routers or other hardware to route signals among nodes 1030. Additionally, fabric 1070 can couple system 1000 to network 1004 for access by clients 1002. In addition to routing equipment, fabric 1070 can be considered to include the cables or ports or other hardware equipment to couple nodes 1030 together. In one example, fabric 1070 has one or more associated protocols to manage the routing of signals through system 1000. In one example, the protocol or protocols is at least partly dependent on the hardware equipment used in system 1000.

As illustrated, rack 1010 includes N blades 1020. In one example, in addition to rack 1010, system 1000 includes rack 1050. As illustrated, rack 1050 includes M blade components, blade 1060[0], . . . , blade 1060 [M−1], collectively blades 1060. M is not necessarily the same as N; thus, it will be understood that various different hardware equipment components could be used, and coupled together into system 1000 over fabric 1070. Blades 1060 can be the same or similar to blades 1020. Nodes 1030 can be any type of node and are not necessarily all the same type of node. System 1000 is not limited to being homogenous, nor is it limited to not being homogenous.

The nodes in system 1000 can include compute nodes, memory nodes, storage nodes, accelerator nodes, or other nodes. Rack 1010 is represented with memory node 1022 and storage node 1024, which represent shared system memory resources, and shared persistent storage, respectively. One or more nodes of rack 1050 can be a memory node or a storage node.

Nodes 1030 represent examples of compute nodes. For simplicity, only the compute node in blade 1020[0] is illustrated in detail. However, other nodes in system 1000 can be the same or similar. At least some nodes 1030 are computation nodes, with processor (proc) 1032 and memory 1040. A computation node refers to a node with processing resources (e.g., one or more processors) that executes an operating system and can receive and process one or more tasks. In one example, at least some nodes 1030 are server nodes with a server as processing resources represented by processor 1032 and memory 1040.

Memory node 1022 represents an example of a memory node, with system memory external to the compute nodes. Memory nodes can include controller 1082, which represents a processor on the node to manage access to the memory. The memory nodes include memory 1084 as memory resources to be shared among multiple compute nodes.

Storage node 1024 represents an example of a storage server, which refers to a node with more storage resources than a computation node, and rather than having processors for the execution of tasks, a storage server includes processing resources to manage access to the storage nodes within the storage server. Storage nodes can include controller 1086 to manage access to the storage 1088 of the storage node.

In one example, node 1030 includes interface controller 1034, which represents logic to control access by node 1030 to fabric 1070. The logic can include hardware resources to interconnect to the physical interconnection hardware. The logic can include software or firmware logic to manage the interconnection. In one example, interface controller 1034 is or includes a host fabric interface, which can be a fabric interface in accordance with any example described herein. The interface controllers for memory node 1022 and storage node 1024 are not explicitly shown.

Processor 1032 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory 1040 can be or include memory devices represented by memory 1040 and a memory controller represented by controller 1042.

In general with respect to the descriptions herein, in one aspect, a memory device includes: a register having a bit field to control entry of the memory device into an alert signal test mode; a hardware interface to an alert signal line between the memory device and a memory controller; and interface circuitry to couple to the memory controller, the interface circuitry to receive a command to set the bit field to a value to cause the memory device to enter the alert signal test mode, the memory device to assert the alert signal line with an alert signal in response to entry into the alert signal test mode.

In one example of the memory device, the register comprises a mode register. In accordance with any preceding example of the memory device, in one example, the command comprises a mode register write (MRW) command. In accordance with any preceding example of the memory device, in one example, the bit field comprises a write-only bit field that is self-clearing. In accordance with any preceding example of the memory device, in one example, the memory device to assert the alert signal comprises the hardware interface to pull the alert signal line to a logic low. In accordance with any preceding example of the memory device, in one example, the memory device is to assert the alert signal in response to the entry into the alert signal test mode within a defined delay period. In accordance with any preceding example of the memory device, in one example, the defined delay period comprises a maximum delay from receipt of the command. In accordance with any preceding example of the memory device, in one example, the memory device is further to set an alert backoff (ABO) flag in response to asserting the alert signal. In accordance with any preceding example of the memory device, in one example, assertion of the alert signal is to trigger the memory controller to provide row hammer mitigation for the memory device. In accordance with any preceding example of the memory device, in one example, the row hammer mitigation comprises a refresh management (RFM) command. In accordance with any preceding example of the memory device, in one example, the row hammer mitigation comprises a directed refresh management (DRFM) command. In accordance with any preceding example of the memory device, in one example, the row hammer mitigation comprises an adaptive refresh management (ARFM) command to the memory device. In accordance with any preceding example of the memory device, in one example, the memory device comprises double data rate (DDR) dynamic random access memory (DRAM) device.

In general with respect to the descriptions herein, in one aspect, a system for memory interface testing includes: an alert signal line; a memory controller coupled to the alert signal line; a memory device coupled to the alert signal line, the memory device including a register having a bit field to control entry of the memory device into an alert signal test mode; and interface circuitry to couple to the memory controller, the interface circuitry to receive a command to set the bit field to a value to cause the memory device to enter the alert signal test mode, the memory device to assert the alert signal line with an alert signal in response to entry into the alert signal test mode.

In one example of the system, the register comprises a mode register. In accordance with any preceding example of the system, in one example, the command comprises a mode register write (MRW) command. In accordance with any preceding example of the system, in one example, the bit field comprises a write-only bit field that is self-clearing. In accordance with any preceding example of the system, in one example, the memory device to assert the alert signal comprises the memory device to pull the alert signal line to a logic low. In accordance with any preceding example of the system, in one example, the memory device is to assert the alert signal in response to the entry into the alert signal test mode within a defined delay period. In accordance with any preceding example of the system, in one example, the defined delay period comprises a maximum delay from receipt of the command. In accordance with any preceding example of the system, in one example, the memory device is to assert the alert signal in response to the entry into the alert signal test mode within a defined delay period that indicates a maximum delay from receipt of the command. In accordance with any preceding example of the system, in one example, the memory device is further to set an alert backoff (ABO) flag in response to asserting the alert signal. In accordance with any preceding example of the system, in one example, assertion of the alert signal is to trigger the memory controller to provide row hammer mitigation for the memory device. In accordance with any preceding example of the system, in one example, the row hammer mitigation comprises a refresh management (RFM) command. In accordance with any preceding example of the system, in one example, the row hammer mitigation comprises a directed refresh management (DRFM) command. In accordance with any preceding example of the system, in one example, the row hammer mitigation comprises an adaptive refresh management (ARFM) command to the memory device. In accordance with any preceding example of the system, in one example, the memory device comprises double data rate (DDR) dynamic random access memory (DRAM) device. In accordance with any preceding example of the system, in one example, the system includes a host processor coupled to a memory controller. In accordance with any preceding example of the system, in one example, the system includes a display communicatively coupled to a host processor. In accordance with any preceding example of the system, in one example, the system includes a network interface communicatively coupled to a host processor. In accordance with any preceding example of the system, in one example, the system includes a battery to power the system.

In general with respect to the descriptions herein, in one aspect, a memory controller includes: a hardware interface to an alert signal line between the memory controller and a memory device; and interface circuitry to couple to the memory device, the interface circuitry to send a command to set a bit field in a register of the memory device to control entry of the memory device into an alert signal test mode; wherein the memory controller is to receive an alert signal on the alert signal line from the memory device in response to entry into the alert signal test mode.

In one example of the memory controller, the register of the memory device comprises a mode register. In accordance with any preceding example of the memory controller, in one example, the command comprises a mode register write (MRW) command. In accordance with any preceding example of the memory controller, in one example, the bit field comprises a write-only bit field that is self-clearing. In accordance with any preceding example of the memory controller, in one example, the memory device to assert the alert signal comprises the hardware interface to pull the alert signal line to a logic low. In accordance with any preceding example of the memory controller, in one example, the memory device is to assert the alert signal in response to the entry into the alert signal test mode within a defined delay period. In accordance with any preceding example of the memory controller, in one example, the defined delay period comprises a maximum delay from receipt of the command. In accordance with any preceding example of the memory controller, in one example, the memory device is further to set an alert backoff (ABO) flag in response to asserting the alert signal. In accordance with any preceding example of the memory controller, in one example, assertion of the alert signal is to trigger the memory controller to provide row hammer mitigation for the memory device. In accordance with any preceding example of the memory controller, in one example, the row hammer mitigation comprises a refresh management (RFM) command. In accordance with any preceding example of the memory controller, in one example, the row hammer mitigation comprises a directed refresh management (DRFM) command. In accordance with any preceding example of the memory controller, in one example, the row hammer mitigation comprises an adaptive refresh management (ARFM) command to the memory device. In accordance with any preceding example of the memory controller, in one example, the memory device comprises double data rate (DDR) dynamic random access memory (DRAM) device.

In general with respect to the descriptions herein, in one aspect, a method for performing an alert signal test includes: receiving a command at a memory device to set a bit field of a register to a value to cause the memory device to enter an alert signal test mode; and asserting an alert signal on an alert signal line between the memory device and a memory controller in response to entry into the alert signal test mode.

In one example of the method, the register comprises a mode register. In accordance with any preceding example of the method, in one example, the command comprises a mode register write (MRW) command. In accordance with any preceding example of the method, in one example, the bit field comprises a write-only bit field that is self-clearing. In accordance with any preceding example of the method, in one example, asserting the alert signal comprises pulling the alert signal line to a logic low. In accordance with any preceding example of the method, in one example, asserting the alert signal comprises asserting the alert signal within a defined delay period after entry into the alert signal test mode. In accordance with any preceding example of the method, in one example, the defined delay period comprises a maximum delay from receipt of the command. In accordance with any preceding example of the method, in one example, the method includes setting an alert backoff (ABO) flag in response to asserting the alert signal. In accordance with any preceding example of the method, in one example, asserting the alert signal triggers the memory controller to provide row hammer mitigation for the memory device. In accordance with any preceding example of the method, in one example, the row hammer mitigation comprises a refresh management (RFM) command. In accordance with any preceding example of the method, in one example, the row hammer mitigation comprises a directed refresh management (DRFM) command. In accordance with any preceding example of the method, in one example, the row hammer mitigation comprises an adaptive refresh management (ARFM) command to the memory device. In accordance with any preceding example of the method, in one example, the memory device comprises double data rate (DDR) dynamic random access memory (DRAM) device.

In general with respect to the descriptions herein, in one aspect, an article of manufacture comprising a computer-readable storage medium having content stored thereon, which when executed causes a machine to perform operations to execute a method for performing an alert signal test including: receiving a command at a memory device to set a bit field of a register to a value to cause the memory device to enter an alert signal test mode; and asserting an alert signal on an alert signal line between the memory device and a memory controller in response to entry into the alert signal test mode.

In one example of the article of manufacture, the register comprises a mode register. In accordance with any preceding example of the article of manufacture, in one example, the command comprises a mode register write (MRW) command. In accordance with any preceding example of the article of manufacture, in one example, the bit field comprises a write-only bit field that is self-clearing. In accordance with any preceding example of the article of manufacture, in one example, asserting the alert signal comprises pulling the alert signal line to a logic low. In accordance with any preceding example of the article of manufacture, in one example, asserting the alert signal comprises asserting the alert signal within a defined delay period after entry into the alert signal test mode. In accordance with any preceding example of the article of manufacture, in one example, the defined delay period comprises a maximum delay from receipt of the command. In accordance with any preceding example of the article of manufacture, in one example, the method includes setting an alert backoff (ABO) flag in response to asserting the alert signal. In accordance with any preceding example of the article of manufacture, in one example, asserting the alert signal triggers the memory controller to provide row hammer mitigation for the memory device. In accordance with any preceding example of the article of manufacture, in one example, the row hammer mitigation comprises a refresh management (RFM) command. In accordance with any preceding example of the article of manufacture, in one example, the row hammer mitigation comprises a directed refresh management (DRFM) command. In accordance with any preceding example of the article of manufacture, in one example, the row hammer mitigation comprises an adaptive refresh management (ARFM) command to the memory device. In accordance with any preceding example of the article of manufacture, in one example, the memory device comprises double data rate (DDR) dynamic random access memory (DRAM) device.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A memory device comprising:
a register having a bit field to control entry of the memory device into an alert signal test mode;
a hardware interface to an alert signal line between the memory device and a memory controller; and
interface circuitry to couple to the memory controller, the interface circuitry to receive a command to set the bit field to a value to cause the memory device to enter the alert signal test mode, the memory device to assert the alert signal line with an alert signal in response to entry into the alert signal test mode.

2. The memory device of claim 1, wherein the register comprises a mode register.

3. The memory device of claim 1, wherein the command comprises a mode register write (MRW) command.

4. The memory device of claim 1, wherein the bit field comprises a write-only bit field that is self-clearing.

5. The memory device of claim 1, wherein the memory device to assert the alert signal comprises the hardware interface to pull the alert signal line to a logic low.

6. The memory device of claim 1, wherein the memory device is to assert the alert signal in response to the entry into the alert signal test mode within a defined delay period.

7. The memory device of claim 6, wherein the defined delay period comprises a maximum delay from receipt of the command.

8. The memory device of claim 1, wherein the memory device is further to set an alert backoff (ABO) flag in response to asserting the alert signal.

9. The memory device of claim 1, wherein assertion of the alert signal is to trigger the memory controller to provide row hammer mitigation for the memory device.

10. The memory device of claim 9, wherein the row hammer mitigation comprises a refresh management (RFM) command, a directed refresh management (DRFM) command, or an adaptive refresh management (ARFM) command to the memory device.

11. The memory device of claim 1, wherein the memory device comprises double data rate (DDR) dynamic random access memory (DRAM) device.

12. A system for memory interface testing, comprising:
an alert signal line;
a memory controller coupled to the alert signal line;
a memory device coupled to the alert signal line, the memory device including
a register having a bit field to control entry of the memory device into an alert signal test mode; and
interface circuitry to couple to the memory controller, the interface circuitry to receive a command to set the bit field to a value to cause the memory device to enter the alert signal test mode, the memory device to assert the alert signal line with an alert signal in response to entry into the alert signal test mode.

13. The system of claim 12, wherein the register comprises a mode register.

14. The system of claim 12, wherein the command comprises a mode register write (MRW) command.

15. The system of claim 12, wherein the bit field comprises a write-only bit field that is self-clearing.

16. The system of claim 12, wherein the memory device to assert the alert signal comprises the memory device to pull the alert signal line to a logic low.

17. The system of claim 12, wherein the memory device is to assert the alert signal in response to the entry into the alert signal test mode within a defined delay period that indicates a maximum delay from receipt of the command.

18. The system of claim 12, wherein the memory device is further to set an alert backoff (ABO) flag in response to asserting the alert signal.

19. The system of claim 12, wherein assertion of the alert signal is to trigger the memory controller to send a refresh management (RFM) command, a directed refresh management (DRFM) command, or an adaptive refresh management (ARFM) command to provide row hammer mitigation for the memory device.

20. The system of claim 12, including one or more of:
a host processor coupled to a memory controller;
a display communicatively coupled to a host processor;
a network interface communicatively coupled to a host processor; or
a battery to power the system.
